(19) United States
(12) Patent Application Publication
(10) Pub. No.: US 2007/0128378 A1
(43) Pub. Date: Jun. 7, 2007

(54) Method of producing liquid crystal aligning layer, liquid crystal aligning layer produced using the same, and liquid crystal display including liquid crystal aligning layer

(76) Inventors: Kyung-Jun Kim, Daejeon Metropolitan City (KR); Byung-Hyun Lee, Daejeon Metropolitan City (KR); Hye-Won Jeong, Daejeon Metropolitan City (KR); Yun-Jeong Lee, Daejeon Metropolitan City (KR)

Correspondence Address: Song K. Jung;MCKENNA LONG & ALDRIDGE LLP, 1900 K Street, N.W., Washington, DC, 20006, US

(21) Appl. No.: 11/606,345

(22) Filed: Nov. 30, 2006

(30) Foreign Application Priority Data
Dec. 1, 2005 (KR) 10-2005-0116611

(51) Int. Cl. C09K 19/00

(52) U.S. Cl. 428/1.2; 428/1.1

(57) ABSTRACT

Disclosed is a method of producing a liquid crystal aligning layer, a liquid crystal aligning layer produced using the same, and a liquid crystal display including the liquid crystal aligning layer. In the liquid crystal aligning layer that is produced using the method, ultraviolet rays are radiated on movable chains of a polyamic acid polymer while the polyamic acid polymer is not imidized to perform alignment, and heat treatment is then performed to conduct imidization. Thus, thermal stability is excellent, residual images are not formed, and alignment of liquid crystals is excellent.

### TECHNICAL FIELD

The present invention relates to a method of producing a liquid crystal aligning layer, a liquid crystal aligning layer produced using the same, and a liquid crystal display including the liquid crystal aligning layer.

This application claims priority from Korean Patent Application No. 10-2005-0116611 filed on Dec. 1, 2005 in the Korean Intellectual Property Office, the disclosure of which is incorporated herein by reference in its entirety.

### BACKGROUND ART

In accordance with the advance in the display industry, a low driving voltage, high resolution, reduction in volume of the monitor, and flatness of the monitor are realized in a liquid crystal display field. Accordingly, demands for liquid crystal displays are significantly growing. In liquid crystal display technologies, it is essential to align liquid crystals in a desired direction.

In the current LCD (liquid crystal display) industry, a contact-type rubbing process is used as a known process of aligning liquid crystals. The process includes applying a polymer film formed of a polymer such as polyimide on a substrate such as glass, and rubbing a surface of the resulting substrate using fibers such as nylon and polyester in a predetermined direction. Alignment of the liquid crystals using the contact-type rubbing process is advantageous in that stable alignment ability of the liquid crystals is assured using a simple process. However, problems may occur during the production of liquid crystal panels due to the damage to the substrate caused by fine dust or electrostatic discharge (ESD) generated when the fibroid materials are rubbed with the polymer film, and the troubles of the process such as the increased process time and nonuniform rubbing strength resulting from the use of large rolls according to the use of enlarged glass.

Recently, many studies have been made to produce an aligning layer using a novel contactless-type process in order to avoid the above problems of the contact-type rubbing process. Examples of the contactless-type process of producing the aligning layer include an optical alignment process, an energy beam alignment process, a vapor deposition alignment process, and an etching process using lithography. However, the contactless-type aligning layer is difficult to be commercialized due to low thermal stability and residual images as compared to the aligning layer produced using the contact-type rubbing.

Particularly, in the case of the photoaligning layer, since thermal stability is significantly reduced and the residual images are maintained for a long time, the photoaligning layer cannot be commercially produced even though convenience of the process is assured.

With respect to improvement in thermal stability, Korean Patent No. 10-0357841 discloses novel linear and cyclic polymers or oligomers of coumarin and quinolinol derivatives having the photoreactive ethene group, and the use of the polymers or the oligomers as the liquid crystal aligning layer. However, the patent is problematic in that residual images are very easily formed due to a rod-shaped mesogen bonded to a main chain.

To avoid the above-mentioned problem regarding the residual images, Korean Patent No. 10-0258847 suggests a liquid crystal aligning layer that is mixed with a thermosetting resin or has a functional group capable of being thermally cured. However, the patent is problematic in that alignment and thermal stability are poor.

It is known that examples of the photoreaction using radiation of ultraviolet rays include the photoreaction of cinnamate, coumarin or the like, the photo-isomerization reaction of cis-trans isomerization, and breaking of the molecular chain due to decomposition. There are some examples of the application of the molecular photoreaction using ultraviolet rays to the alignment of the liquid crystals using the radiation of ultraviolet rays by means of the desirable design of the aligning layer molecule and optimization of the radiation condition of ultraviolet rays. With respect to the examples, many patents have been suggested in LCD industry field of Japan, Korea, Europe, and the U.S.A since the patent of Gibbons and Schadt had been announced in the year 1991. However, the above-mentioned technologies are not applied to LCDs even after 10 years that the initial idea was suggested. The reason for this is as follows. Even though the alignment of the liquid crystals may be performed using the photoreaction, it is impossible to maintain or provide the stable alignment of the liquid crystals against heat, light, physical impact, and chemical impact. This is mainly caused by poor anchoring energy, poor stability of the alignment of the liquid crystals, residual images or the like, as compared with the rubbing process.

Most of known studies and patents have been made to overcome the above-mentioned problems by design of photosensitive functional groups. To achieve this, there was an attempt to deform molecular structures. However, a desirable solution has not been suggested. The reason is believed that it is difficult to maintain the stable alignment of liquid crystals using only photoreaction.

Additionally, the known liquid crystal aligning layer which contains polyimide is subjected to heat treatment and then aligned in both a rubbing process and a process using ultraviolet rays so that imidization of the polyamic acid is fully achieved. However, the liquid crystal aligning layer which is produced through the above-mentioned procedure is problematic in that thermal stability is significantly reduced and the residual image is continued for a long time.

### Disclosure

### Technical Problem

The present inventors have conducted studies into a liquid crystal aligning layer having excellent thermal stability and no residual image, resulting in the finding that a liquid crystal alignment solution is prepared while a polyamic acid copolymer is not subjected to imidization, applied on a substrate, aligned, and subjected to an imidization process to produce a liquid crystal aligning layer having excellent thermal stability, no residual images, and excellent alignment of liquid crystals, thereby accomplishing the present invention.

An object of the present invention is to provide a method of producing a liquid crystal aligning layer.

Another object of the present invention is to provide a liquid crystal aligning layer that is produced using the method.

Still another object of the present invention is to provide a liquid crystal display that includes the liquid crystal aligning layer.

### Technical Solution

The present invention provides a method of producing a liquid crystal aligning layer. The method comprises the steps of

1) dissolving a polyamic acid copolymer in an organic solvent to prepare a liquid crystal alignment solution, and applying the liquid crystal alignment solution to a surface of a substrate to form a coat layer,

2) drying the solvent that is contained in the coat layer,

3) radiating polarized ultraviolet rays on the dried coat layer to perform alignment, and

4) heat treating the aligned coat layer to perform imidization.

### Advantageous Effects

In the case of a liquid crystal aligning layer that is produced using a method of producing the liquid crystal aligning layer according to the present invention, ultraviolet rays are radiated on movable chains of a polyamic acid polymer before the polyamic acid polymer is imidized to perform alignment, and heat treatment is then performed to conduct imidization. Thus, the liquid crystal aligning layer has the advantageous effects that thermal stability is excellent, residual images are not formed, and alignment of liquid crystals is excellent.

### DESCRIPTION OF THE DRAWINGS

FIG. 1 illustrates thermal stability of a liquid crystal aligning layer according to the present invention;

FIG. 2 illustrates thermal stability of a liquid crystal aligning layer produced in Comparative example 1 (in black rectangular regions, polarized ultraviolet rays are radiated to align liquid crystals, and, in grey edges, the liquid crystals are not aligned); and

FIG. 3 illustrates alignment of liquid crystals of the liquid crystal aligning layer that is produced using a method of producing the liquid crystal aligning layer according to the present invention and a known liquid crystal aligning layer.

### BEST MODE

Hereinafter, the present invention will be described in detail.

In step 1, a polyamic acid copolymer may be represented by the following Formula 1.

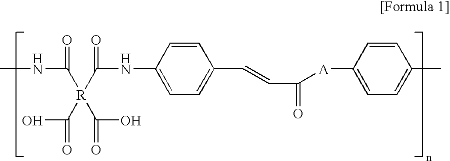

In Formula 1, R is a tetravalent organic group, A is —NH— or —O—, and n is an integer of 1 to 1,000.

In Formula 1, R is preferably selected from the group consisting of the following structural formulae.

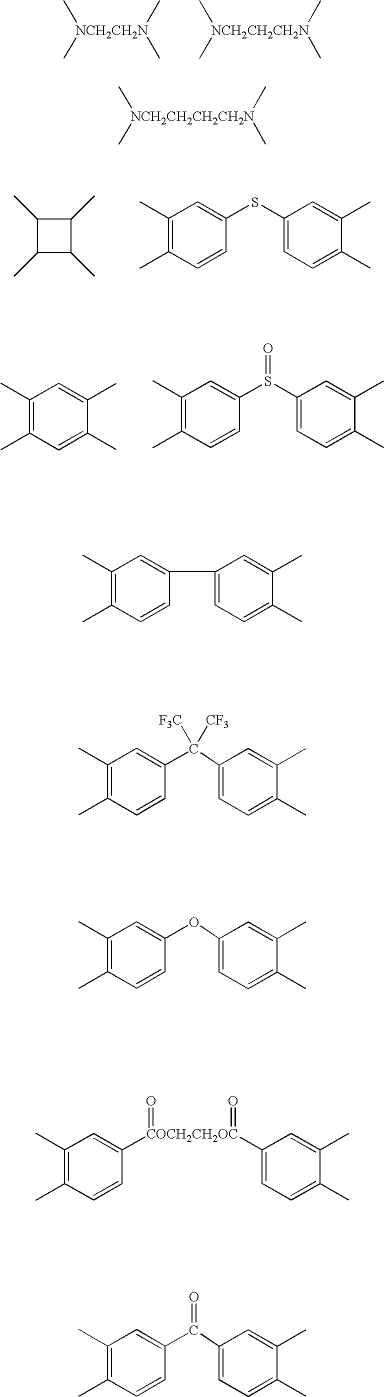

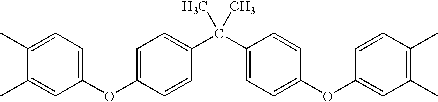

In step 1, the concentration of liquid crystal alignment solution, the type of solvent, and the type of coating process may depend on the type and the use of the polyamic acid copolymer shown in the above Formula 1.

In step 1, examples of an organic solvent include, but are not limited to cyclopentanone, cyclohexanone, N-methylpyrrolidone, DMF (dimethylformamide), THF (tetrahyrofuran), CCl₄, and a mixture thereof.

Additionally, after the coating is performed, in order to assure uniformity of the thickness of the liquid crystal aligning layer and to prevent printing defects, a solvent such as ethylene glycol monoethyl ether acetate, ethylene glycol monoisopropyl ether, and ethylene glycol monomethyl ether may be used in combination with the above-mentioned organic solvent.

The liquid crystal alignment solution of step 1 may be applied on a surface of a substrate on which a transparent conductive layer or a metal electrode is patterned using a process such as a roll coater process, a spinner process, a printing process, an inkjet spray process, and a slit nozzle process.

Furthermore, during the application of the liquid crystal alignment solution, in order to improve adhesion of the surface of the substrate to the transparent conductive layer, the metal electrode, and the coat layer, a functional silane-containing compound, a functional fluorine-containing compound, and a functional titanium-containing compound may be applied in advance.

During the production of the liquid crystal alignment solution of step 1, the temperature is 0 to 100° C., and preferably 15 to 70° C.

In step 2, the solvent may be dried over using the heating of the coat layer or a vacuum vaporization process.

When the solvent is dried in step 2, the drying is performed at 35 to 80° C., and preferably 50 to 75° C., within 3 min.

If the substrate is heated at 80° C. or more during the drying of the solvent, since the imidization reaction of the polyamic acid copolymer is performed before the alignment process, the alignment of liquid crystals may be reduced after the alignment process. Accordingly, in the method of producing the liquid crystal aligning layer according to the present invention, only the solvent that is contained in the coat layer after the liquid crystal alignment solution is applied is subjected to heat treatment or vacuum vaporization. Thereby, the polyamic acid copolymer is present while being not polyimidized.

In step 3, ultraviolet rays having a wavelength of 150 to 450 nm may be radiated on the dried coat layer that is formed in step 2 to perform the alignment. In connection with this, the intensity of exposure depends on the type of polyamic acid copolymer shown in the above Formula 1, and energy of 50 mJ/cm² to 10 J/cm², and preferably 500 mJ/cm² to 5 J/cm², may be radiated.

The alignment is performed by the radiation of ultraviolet rays that are polarized by means of transmission or reflection of the ultraviolet rays with respect to \textcircled{1} a polarizing device using a transparent substrate, such as quartz glass, soda lime glass, and soda lime-free glass, a surface of which is coated with dielectric isotropic material, \textcircled{2} a polarizing plate on which aluminum or metal wires are finely deposited, or \textcircled{3} a Brewster polarizing device using reflection of quartz glass. In connection with this, the polarized ultraviolet rays may be perpendicularly radiated to the substrate, or inclinedly at a predetermined angle. Thereby, the desirable alignment of liquid crystal molecules is provided to the coat layer.

In step 4, the layer in which the liquid crystals are aligned by the radiation of the polarized ultraviolet rays may be heated at 80 to 300° C., and preferably 115 to 300° C., for 15 min or more to perform stabilization. The polyamic acid copolymer is subjected to ring-closing dehydration through the heat treatment process to be converted into a polyimide copolymer.

The polyimide copolymer may be represented by the following Formula 2.

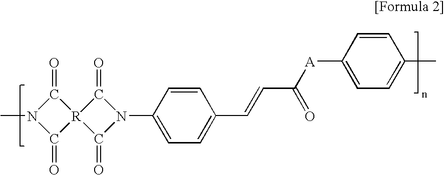

In Formula 2, R is a tetravalent organic group, A is —NH— or —O—, and n is an integer of 1 to 1,000.

In the above Formula 2, R is preferably selected from the group consisting of the following structural formulae.

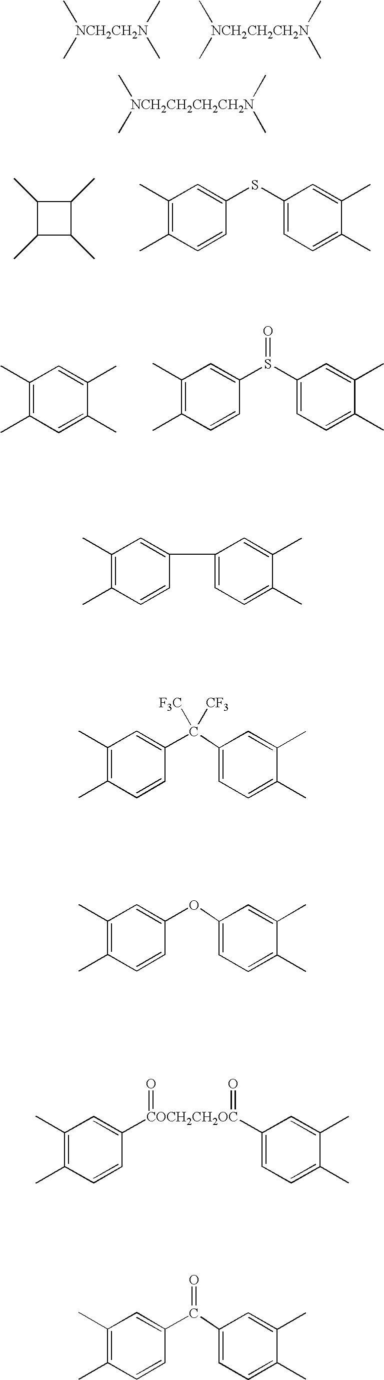

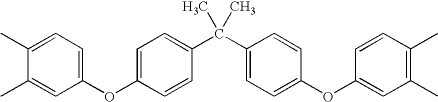

After step 4, in the liquid crystal aligning layer, the concentration of the solid of the polyimide copolymer is selected in consideration of the molecular weight, viscosity, and volatility of the polyamic acid copolymer, and preferably selected in the range of 0.5 to 20% by weight. In this case, the concentration of the solid of the polyimide copolymer varies according to the molecular weight of the polyamic acid copolymer. If the concentration of the solid of the polyimide copolymer is 0.5% by weight or less even though the molecular weight of the polyamic acid copolymer is sufficiently high, since the thickness of the liquid crystal aligning layer is very small, it is difficult to obtain the desirable alignment of liquid crystals. If the concentration is more than 20% by weight, since the viscosity of the liquid crystal alignment solution that is used to produce the liquid crystal aligning layer is excessively increased, coating property is reduced. Additionally, the thickness of the liquid crystal aligning layer is very large, it is difficult to obtain the desirable alignment of liquid crystals.

The thickness of the final coat layer that is formed through the above-mentioned procedure is 0.002 to 2 μm. It is preferable that the thickness be in the range of 0.004 to 0.6 μm in order to produce the desirable liquid crystal display device.

After the above-mentioned procedure, it is possible to produce a photoaligning layer having the liquid crystal alignment that is stable to external heat and physical and chemical impacts.

Furthermore, the present invention provides a liquid crystal aligning layer that is produced using the method.

The liquid crystal aligning layer according to the present invention may include typical solvents or additives that are known in the related arts in addition to the polyimide copolymer shown in the above Formula 2.

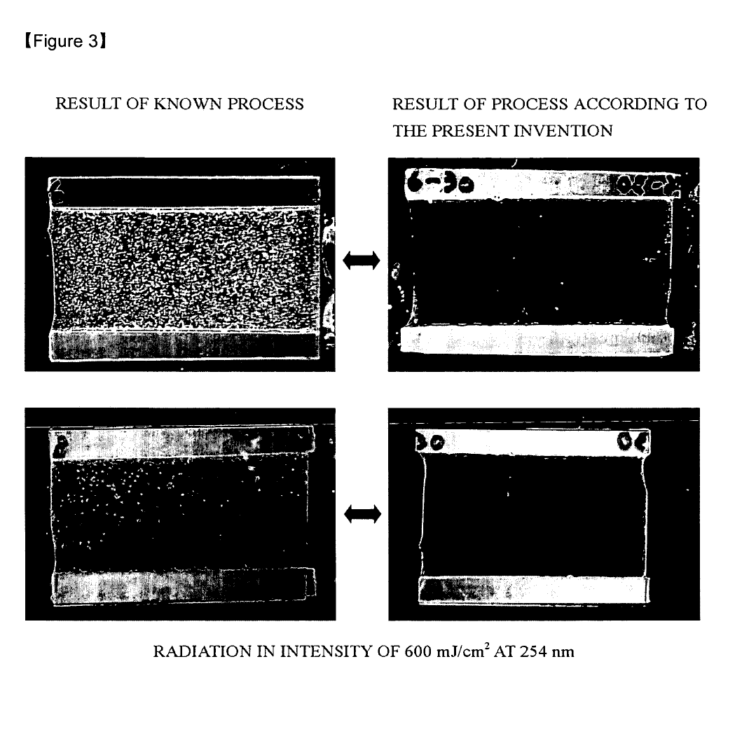

In the case of the liquid crystal aligning layer that is produced using the method of producing the liquid crystal aligning layer according to the present invention, ultraviolet rays are radiated on movable chains of the polyamic acid polymer before the polyamic acid polymer is imidized to perform alignment, and heat treatment is then performed to conduct imidization. Thus, thermal stability is excellent, residual images are not formed, and alignment of liquid crystals is excellent as compared to a known method that includes radiating ultraviolet rays after the polyamic acid is imidized to perform alignment (FIG. 3).

Additionally, the present invention provides a liquid crystal display that includes the liquid crystal aligning layer.

The liquid crystal display may be produced using a typical method that is known in the related arts.

The liquid crystal display that includes the liquid crystal aligning layer according to the present invention has excellent thermal stability and no residual images.

### Mode for Invention

A better understanding of the present invention may be obtained in light of the following Example which are set forth to illustrate, but are not to be construed to limit the present invention.

### EXAMPLE 1

### 1. Production of the Polyamic Acid Copolymer

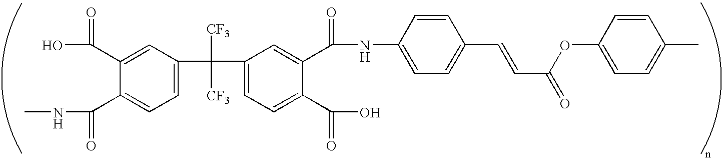

### 1-1. Preparation of (4′-nitrophenyl)-4-nitrocinnamate

19.32 g (0.1 mole) of 4-nitrocinnamic acid was put into the reaction vessel, and a small amount of DMF and 60 g of thionyl chloride were added under a nitrogen atmosphere. The mixture was heated to 70° C. while being stirred until the solution was transparent. Unreacted thionyl chloride was removed at a reduced pressure to prepare 20 g of 4-nitrocinnamoyl chloride. 6.6 g (0.047 mole) of 4-nitrophenol, 7 mL of triethylamine, and 500 mL of tetrahydrofuran were put into the reaction vessel while they were stirred under a nitrogen atmosphere. The solution of 10 g (0.047 mole) of 4-nitrocinnamoyl chloride in 40 mL of tetrahydrofuran was slowly added to the former solution, and the reaction temperature was maintained at 0C. The mixture was stirred at room temperature for 12 hours. The resulting solution was dried over at the reduced pressure, and then extracted with methylene chloride and water. The methylene chloride layer was concentrated to prepare 12 g of (4′-nitrophenyl)-4-nitrocinnamate.

### 1-2. Preparation of (4′-aminophenyl)-4-aminocinnamate

3.14 g (0.01 mole) of (4′-nitrophenyl)-4-nitrocinnamate that was prepared according to No. 1-1, 20 mL of water, and 100 mL of isopropanol were put into the reaction vessel. The mixture was heated to 70° C. while being stirred. 3 mL of conc. HCl and 20 g of iron powder were added to the reaction vessel. After 12 hours, the solution was filtered to remove unreacted iron. The filtered solution was concentrated, and then diluted with water. The resulting solution was neutralized with a sodium hydroxide aqueous solution, and then extracted with methylene chloride. The methylene chloride layer was concentrated and recrystallized to prepare 2.1 g of (4′-aminophenyl) -4-aminocinnamate.

### 1-3. Preparation of the Polyamic Acid Copolymer

3.50 g (0.0138 mole) of (4′-aminophenyl)-4-nitrocinnamate that was prepared according to No. 1-2, and 60 mL of NMP (N-methylpyrrolidone) were put into the reaction vessel that was provided with the agitator. 6.12 g (0.0138 mole) of 4,4′-(hexafluoroisopropylidene) diphthalic dianhydride (6-FDA) was added at room temperature, and stirred for 20 hours to prepare a viscous polyamic acid copolymer solution.

IR: 1784, 1725, 1630, 1369, 729 cm⁻¹.

### 2. Preparation of the Liquid Crystal Alignment Solution

The polyamic acid copolymer that was prepared according to No. 1 was dissolved in the mixture of N-methylpyrrolidone and butylcellosolve so that the concentration of nonvolatile components of the polyamic acid copolymer was 2%, and then filtered using the filter of 0.2 μm to prepare the liquid crystal alignment solution.

### 3. Production of the Liquid Crystal Aligning Layer

The liquid crystal alignment solution that was prepared according to No. 2 was applied to the glass substrate on which the indium tin oxide (ITO) electrode was formed to the thickness of 80 nm. The glass substrate was dried at 80° C. within 3 min to remove the solvent. Ultraviolet rays were inclinedly radiated on the surface of the glass substrate on which the liquid crystal alignment solution was applied at the inclination angle of 0 to 30° at the intervals of 5 sec, 10 sec, 30 sec, 1 min, 5 min, and 10 min to cause the photoreaction. After the photoreactive adhesive that contained ball spacers was applied on an edge of any one substrate of the two glass substrates that were subjected to the photoreaction, another glass substrate was attached to the glass substrate having the adhesive, and ultraviolet rays were radiated on only a portion of the glass substrate on which the adhesive was applied to perform the attachment. Liquid crystals were injected into the produced layer, and then subjected to heat treatment at 200° C. or more for 15 min or more to complete the production of the liquid crystal aligning layer.

### EXAMPLE 2

### 1. Preparation of the Polyamic Acid Copolymer

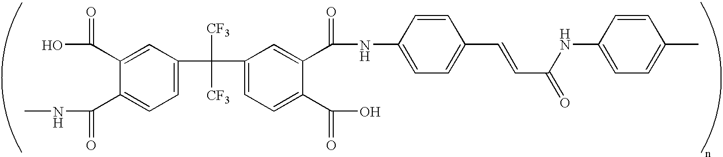

### 1-1. Preparation of (4′-nitrophenyl)-4-nitrocinnamide

19.32 g (0.1 mole) of 4-nitrocinnamic acid was put into the reaction vessel, and a small amount of DMF and 60 g of thionyl chloride were added under a nitrogen atmosphere. The mixture was stirred and heated to 70° C. until the solution was transparent. Unreacted thionyl chloride was removed at a reduced pressure to prepare 20 g of 4-nitrocinnamoyl chloride. 6.5 g (0.047 mole) of 4-nitroaniline, and 60 mL of toluene were put into the reaction vessel while they were stirred under a nitrogen atmosphere. The solution of 10 g (0.047 mole) of 4-nitrocinnamoyl chloride in 10 mL of dioxane was quickly added to the former solution under a nitrogen atmosphere. The mixture was stirred at 110° C. for 6 hours. The resulting solution was dried over at the reduced pressure to prepare 15 g of (4′-nitrophenyl)-4-nitrocinnamide.

### 1-2. Preparation of (4′-aminophenyl)-4-aminocinnamide

5.20 g (0.01 mole) of (4′-nitrophenyl)-4-nitrocinnamide that was prepared according to No. 1-1, 30 mL of water, and 120 mL of isopropanol were put into the reaction vessel. The mixture was heated to 70° C. while being stirred. 5 mL of conc. HCl and 30 g of iron powder were added to the reaction vessel. After 12 hours, the solution was filtered to remove unreacted iron. The filtered solution was concentrated, and then diluted with water. The resulting solution was neutralized with a sodium hydroxide aqueous solution, and then extracted with methylene chloride. The methylene chloride layer was concentrated and recrystallized to prepare 3.8 g of (4′-aminophenyl)-4-aminocinnamide.

### 1-3. Preparation of the Polyamic Acid Copolymer

3.50 g (0.0138 mole) of (4′-aminophenyl)-4-aminocinnamide that was prepared according to No. 1-2, and 60 mL of NMP were put into the reaction vessel that was provided with the agitator. 5.79 g (0.0138 mole) of 4,4′-(hexafluoroisopropylidene) diphthalic dianhydride (6-FDA) was added at room temperature, and stirred for 20 hours to prepare a viscous polyamic acid copolymer solution.

IR: 1782, 1722, 1650, 1633, 1372, 727 cm⁻¹.

### 2. Preparation of the Liquid Crystal Alignment Solution

In the same manner as in No.2 of Example 1, the liquid crystal alignment solution was prepared, except that the polyamic acid copolymer (100 mg) prepared according to No. 1 was used instead of the polyamic acid copolymer of Example 1.

### 3. Production of the Liquid Crystal Aligning Layer

In the same manner as in No.3 of Example 1, the liquid crystal aligning layer was produced using the liquid crystal alignment solution produced according to No. 2.

### COMPARATIVE EXAMPLE 1

### 1. Preparation of Polyimide

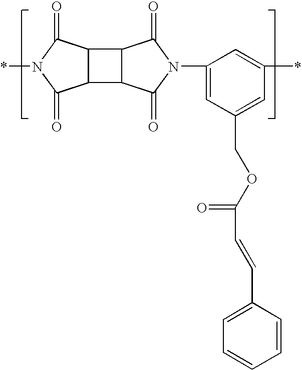

### 1-1. Preparation of (E)-3,5-dinitrobenzyl cinnamate

After 35 mL of acetone was put into a round-bottom flask of 50 mL, 9.90 g (50 mmol) of dinitrobenzyl alcohol was dissolved. 3.87 mL (50 mmol) of pyridine was added to the solution and stirred. 8.33 g (50 mmol) of cinnamoyl chloride was dissolved in 35 mL of acetone, and then slowly dropped to the mixture using the dropping funnel. The temperature was increased to 60° C., and the reaction was carried out for 18 hours. After the reaction was finished, acetone was completely removed. The resultant was dissolved in methylene chloride and workup with sodium hydrogen carbonate (NaHCO₃) and a sodium chloride (NaCl) aqueous solution, and dried over with magnesium sulfate (MgSO₄) to prepare 12.36 g of (E)-3,5-didinitrobenzyl cinnamate (yield 75%).

### 1-2. Preparation of (E)-3,5-diaminobenzyl cinnamate

After (E)-3,5-dinitrobenzyl cinnamate that was prepared according to No. 1-1 was dissolved in 150 mL of acetone at 60° C., and 10 mL of H₂O was added. As a result, white crystals were produced. 60 mL of acetone was added to dissolve the crystals. After the crystals were completely dissolved, 21 g of Fe was added and stirred for about 5 min to be dispersed desirably. Unreacted iron was then removed, 1 mL of HCl was slowly added. After the reaction was carried out for about 30 min, iron and HCl were added in the same amount, and then the reaction was carried out for 18 hours. The reaction was completed, iron was filtered using the filter, the solvent was completely removed, and the resultant was dissolved in methylene chloride. After the solution was subjected to workup with sodium hydroxide and sodium chloride, water was removed with magnesium sulphate, and the solvent was removed to prepare 7 g of (E)-3,5-diaminobenzyl cinnamate (yield 60%).

### 1-3. Preparation of the Polyamic Acid

After 3.5 g (13 mmol) of (E)-3,5-diaminobenzyl cinnamate which was prepared according to No. 1-2 was stirred in 24.24 g (20% by weight) of N-methyl-2-pyrrolidone until being completely dissolved, 2.56 g (13 mmol) of 1,2,3,4-cyclobutane-tetracarboxylic dianhydride (CBDA) was added. And the reaction was carried out for 12 hours in an ice bath. All the reaction was carried out under a N₂ atmosphere. After the reaction was completed, the resultant was precipitated in H₂O to prepare the polyamic acid.

### 1-4. Preparation of Polyimide

0.435 g (PAA repeating unit:acetic anhydride=1:5) of acetic anhydride was added to 2 g (PAA: 0.4 g, NMP: 1.6 g) of the polyamic acid solution that was prepared according to No. 1-3, and 0.201 mL (Ac₂O/pyridine=2/1 volume ratio) of pyridine was added, and the reaction was carried out for 12 hours. After the reaction was completed, the resultant was precipitated in methanol to prepare polyimide.

### 2. Preparation of the Liquid Crystal Alignment Solution

In the same manner as in No. 2 of Example 1, the liquid crystal alignment solution was prepared, except that polyimide (100 mg) prepared according to No. 1 was used instead of the polyamic acid copolymer of Example 1.

### 3. Production of the Liquid Crystal Aligning Layer

The liquid crystal alignment solution that was prepared according to No. 2 was applied to the glass substrate on which the indium tin oxide (ITO) electrode was formed to the thickness of 80 nm. The glass substrate was dried at 80° C. within 3 min to remove the solvent. The dried layer was subjected to heat treatment at 200° C. or more for 15 min or more. Ultraviolet rays having the wavelength in the range of 150 to 450 nm were radiated on the surface of the layer that was subjected to the heat treatment to perform the alignment. Two glass substrates that were subjected to the alignment were attached to each other while the surfaces of the substrates that were subjected to the alignment faced each other. In connection with this, two resulting structures in which the distance between the two attached glass substrates, that is, the gap, is 60 to 90 μm and 4 to 5 μm were produced. In the case of the cell having the gap of 60 μm or more, the double-sided tape was used to perform the attachment. In the case of the cell having the gap of 5 μm or less, after the ball spacers or the column spacers were formed on the glass substrate, the fixing was performed using the UV sealant to produce the test cells having a predetermined gap. The liquid crystals were injected into the cells by the capillary action to produce the liquid crystal aligning layer.

### EXPERIMENTAL EXAMPLE 1

### Evaluation of Initial Alignment of the Liquid Crystal Aligning Layer According to the Present Invention

In order to evaluate the initial alignment of the liquid crystal aligning layer according to the present invention, the following test was performed.

The liquid crystal aligning layers that were produced according to Examples 1 and 2 and Comparative example 1 were put on the light box having the polarizing plate attached thereto, and another polarizing plate was provided the liquid crystal aligning layers so that the two polarizing plates were intersect to observe the liquid crystal alignment of the aligning layers. The liquid crystal alignment was evaluated based on the traces of the flowing liquid crystals and light leakage.

The results are described in the following Table 1.

TABLE 1

| | Exposure for | Exposure for | Exposure for |
|---|---|---|---|
| Aligning layer | 10 sec | 50 sec | 250 sec |
| Example 1 | Excellent | Excellent | Good |
| Example 2 | Excellent | Excellent | Good |
| Comparative | Acceptable | Acceptable | Very poor |
| example 1 | | | |

As shown in Table 1, in the case of the liquid crystal aligning layers according to the present invention (Examples 1 and 2), the excellent alignment was assured without defects as a result of the observation with the naked eye. Additionally, in the case of the liquid crystal aligning layer according to Comparative example 1, the initial alignment was acceptable.

### EXPERIMENTAL EXAMPLE 2

### Evaluation of Thermal Stability of the Liquid Crystal Aligning Layer According to the Present Invention

Thermal stability of the liquid crystal aligning layer according to the present invention was evaluated using the following test.

During the production of a liquid crystal aligning layers according to Examples 1 and 2, spin coating was performed, the solvent was dried off, and the exposing and heat treatments were performed. Then, the single substrate was heat treated at 280° C. for 30 min to produce a liquid crystal aligning layer. The thermal stability of the single substrate was evaluated based on the alignment of the liquid crystal.

The liquid crystal aligning layer that was produced according to Comparative example 1 was subjected to the heat treatment at 140° C., 160° C., and 180° C. for 1 hour. The thermal stability of the resulting liquid crystal aligning layer was evaluated based on the alignment of the liquid crystals.

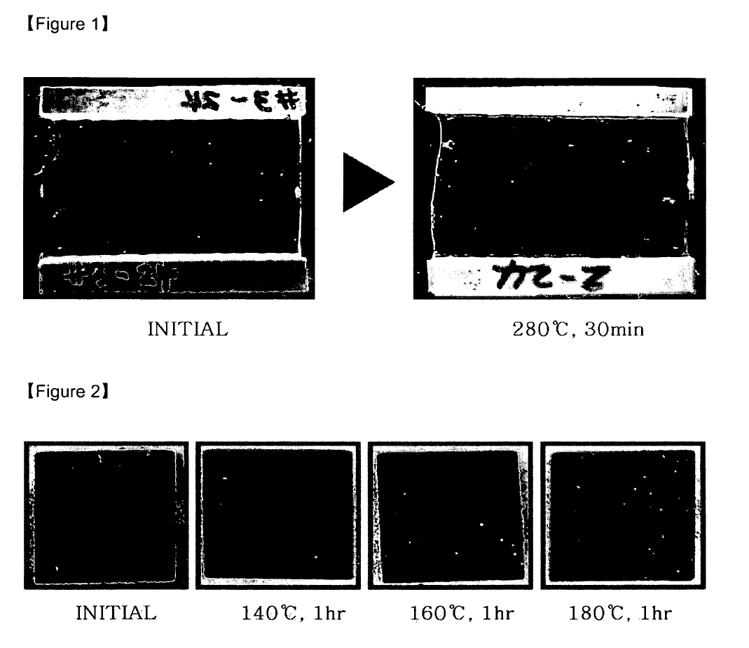

The thermal stability of the liquid crystal aligning layer according to the present invention is shown in FIG. 1. The thermal stability of the liquid crystal aligning layer produced according to Comparative example 1 is shown in FIG. 2.

As shown in FIG. 1, in the case of the liquid crystal aligning layer according to the present invention, the initial alignment was maintained even after the heat treatment was performed at 280° C. for 30 min.

On the other hand, in the case of the liquid crystal aligning layer produced according to Comparative example 1, as shown in FIG. 2, the initial alignment was relatively good. However, since the number of disclinations that were observed as white points was increased as the temperature of the heat treatment was increased, the alignment of the liquid crystals was reduced due to heat, and the thermal stability was not improved. This means that, even though the substance having the high thermal stability is applied to the polymer main chain of the side-chain type of liquid crystal aligning layer, it is impossible to improve the thermal stability.

### INDUSTRIAL APPLICABILITY

Therefore, the liquid crystal aligning layer according to the present invention is useful to volatilize broken parts of the molecular chain which are generated due to the side reaction during radiation of light. Additionally, since the liquid crystal aligning layer is fixed to the molecular chain of the aligning layer, the liquid crystal aligning layer is useful to suppress generation of residual images in a liquid crystal display.

1. A method of producing a liquid crystal aligning layer, comprising the steps of:
1) dissolving a polyamic acid copolymer in an organic solvent to prepare a liquid crystal alignment solution, and applying the liquid crystal alignment solution to a surface of a substrate to form a coat layer;
2) drying the solvent that is contained in the coat layer;
3) radiating polarized ultraviolet rays on the dried coat layer to perform alignment; and
4) heat treating the aligned coat layer to perform imidization.

2. A liquid crystal aligning layer produced using the method of producing a liquid crystal aligning layer according to claim 1.

3. A liquid crystal display including the liquid crystal aligning layer according to claim 2.

4. The method of producing a liquid crystal aligning layer according to claim 1,
wherein the polyamic acid copolymer of step 1 is represented by Formula 1: 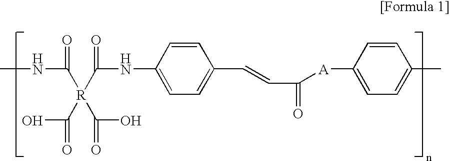
wherein R is a tetravalent organic group, A is —NH— or —O—, and n is an integer of 1 to 1,000.

5. A liquid crystal aligning layer produced using the method of producing a liquid crystal aligning layer according to claim 4.

6. A liquid crystal display including the liquid crystal aligning layer according to claim 5.

7. The method of producing a liquid crystal aligning layer according to claim 4,
wherein R of Formula 1 is selected from the group consisting of the following structural formulae:

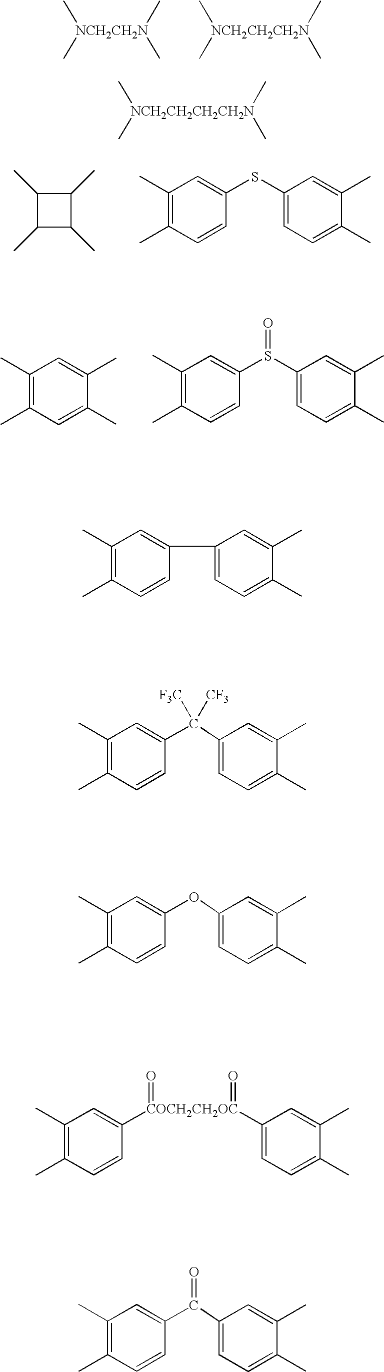

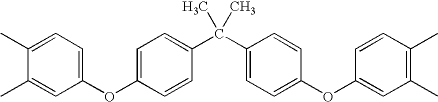

8. A liquid crystal aligning layer produced using the method of producing a liquid crystal aligning layer according to claim 7.

9. A liquid crystal display including the liquid crystal aligning layer according to claim 8.

10. The method of producing a liquid crystal aligning layer according to claim 1,
wherein the solvent is dried at 35 to 80° C. within 3 min in step 2.

11. The method of producing a liquid crystal aligning layer according to claim 1,
wherein the aligned coat layer is heated at 80 to 300° C. for 15 min or more in step 4.

12. The method of producing a liquid crystal aligning layer according to claim 1,
wherein the polyimide copolymer which is prepared using the imidization in step 4 is represented by formula 2: 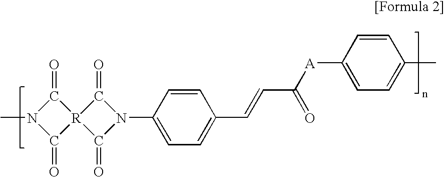
wherein R is a tetravalent organic group, A is —NH— or —O—, and n is an integer of 1 to 1,000.

13. A liquid crystal aligning layer produced using the method of producing a liquid crystal aligning layer according to claim 12.

14. A liquid crystal display including the liquid crystal aligning layer according to claim 13.

15. The method of producing a liquid crystal aligning layer according to claim 12,
wherein R of Formula 2 is selected from the group consisting of the following structural formulae:

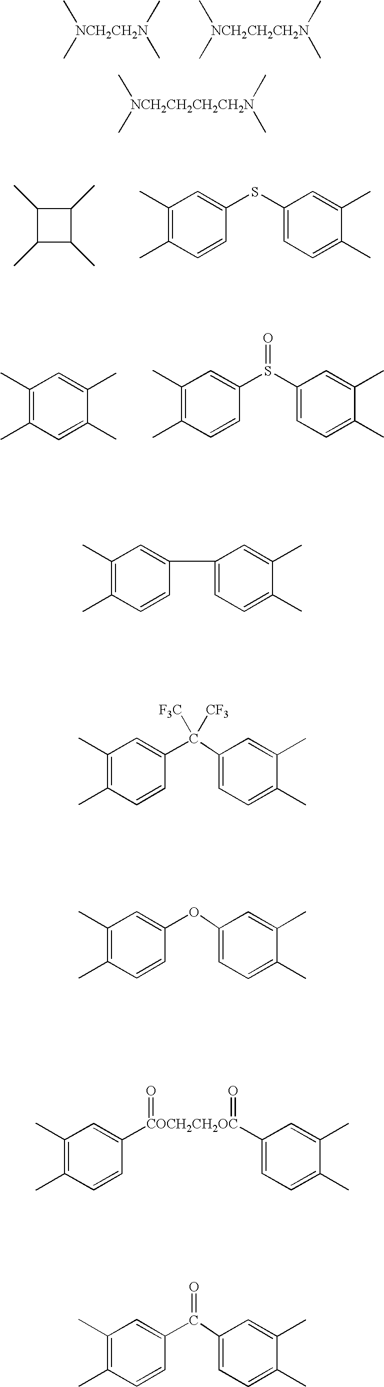

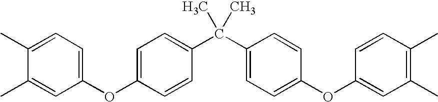

16. A liquid crystal aligning layer produced using the method of producing a liquid crystal aligning layer according to claim 15.

17. A liquid crystal display including the liquid crystal aligning layer according to claim 16.
